(19) United States
(12) Patent Application Publication
(10) Pub. No.: US 2014/0120482 A1
(43) Pub. Date: May 1, 2014

(54) Ceremonial Candle and Sand Apparatus

(71) Applicant: Aaron Moy, Golden Valley, MN (US)

(72) Inventor: Aaron Moy, Golden Valley, MN (US)

(73) Assignee: Aaron Moy, Golden Valley, MN (US)

(21) Appl. No.: 14/064,146

(22) Filed: Oct. 27, 2013

Related U.S. Application Data
(60) Provisional application No. 61/719,386, filed on Oct. 27, 2012.

(51) Int. Cl. F21V 35/00

(52) U.S. Cl. CPC F21V 35/003
USPC 431/291

(57) ABSTRACT

Embodiments of the invention generally provide an enclosure 10 with a candle body 14 securely fitted within the interior of 10. Colored granular material 20 and 22 may be added to the interior of 10 by pouring said 20 and 22 through portal 10′. After the ritual ceremony is performed enclosure 10 and contents within may be kept as a memento of the event.

### CROSS-REFERENCE TO RELATED APPLICATIONS

This application claims the benefit of provisional patent application Ser. No. 61,719,386, filed 2012 Oct. 27 by the present inventor.

### FEDERALLY SPONSORED RESEARCH

Not Applicable

### SEQUENCE LISTING OR PROGRAM

Not Applicable

### BACKGROUND

1. Field of Invention

This invention relates generally to an apparatus used to symbolize the union of two or more parties during a ceremony, such as a marriage, which combines the presentation and lighting of a candle with the pouring of colored granular material inside a vessel. Said vessel may serve as a lasting keepsake token after the event.

2. Prior Art

Contemporary ceremonies where two or more people join together in a personal relationship, such as a marriage or civil union, often include a ritual to symbolize the unity. The most popular rituals employ either a “unity candle” or “sand ceremony.” In the “unity candle” ceremony each person participating holds a small, lit candle of their own. Each person then brings the flaming portion of their candle simultaneously to the wick of a single, common, unlit candle, lighting this common candle. Although documentation for the origins of this method are sparse, such a ceremony was demonstrated on Nov. 17, 1981 in an episode of the fictional television program “General Hospital,” airing on the ABC television network in the United States, where the characters of Luke and Laura participated in a candle ceremony during their wedding scene. Kustka in U.S. Pat. No. 4,555,231 extended the idea of this unity candle by describing a design where multiple candles could be lit and united into one.

In the “sand ceremony” each person participating holds a small container of sand or similar granular material. This sand is uniquely colored for each person participating. Each person then takes a turn pouring a small amount of their sand into a common container, until all the sand has been poured or until the common container can no longer accept more sand. Once again the exact history of this type of ceremony is undocumented, although natives of the Hawaiian islands are chiefly attributed as long having practiced such a ritual at their equivalent of weddings. Awareness and adoption by the popular culture of the unity sand ceremony as described above occurred after such was employed during a wedding on an episode of “The Bachelorette,” airing on Dec. 6, 2003 on the ABC television network in the United States. Although pouring sand into a container may not appear to be a novel idea, inventions in this area have been codified, such as in U.S. Pat. No. 4,457,103, where Aloziem describes an apparatus to decoratively display colored sand in a glass container.

An existing issue is that marrying couples have had to choose either the “unity candle” or the “sand ceremony,” but not both. The apparatus of the present invention enables the marrying parties to combine the “unity candle” and “sand ceremony” into one ritual which provides a lasting physical memento of both actions. The marrying couples can thus experience the benefits of both the unity candle and colored sand during their ceremony, no longer having to choose between one or the other. An alternate attempt to fulfill this approach was presented by Adelusi-adeluyi in U.S. Pat. No. 8,505,725. Here the inventor describes what is predominantly a “sand ceremony apparatus” to permit the display and safe transport of a mix of colored sands in an aesthetically pleasing manner. As an accessory Adelusi-adeluyi postulates that a portion of the invention could be placed above the sand which is “suitable for the receipt of oil therein and a wick extending therefrom.” That is, a small oil lamp “can be suitable for use in a dual sand and unity candle ceremony.” What is important to note here is that the invention of Adelusi-adeluyi may use an oil-based lamp which is separated from the colored decorative sand. This is distinctly different from the present invention which utilizes a traditional candle that is in direct contact and surround by colored granules of sand.

### SUMMARY

The present invention is an apparatus that may be employed during a matrimonial ceremony, such as a wedding or civil union, which combines a unity candle and a sand-mixing ritual into one physical embodiment. The approach of the present invention is applicable to myriad sizes and shapes of containing vessels and candles, and the method of manufacture is uncomplicated. A hollow rigid vessel is provided which has walls which are preferably transparent. Inside this vessel exists a candle, a commonly accepted device consisting of a wax-like material surrounding a filament-like wick which, when ignited, provides a source of light and/or heat. The wick of the candle is in near proximity to an opening at the top of the vessel to enable the lighting of the candle when desired. The opening of the vessel is also sufficient to permit the pouring of granular material, such as colored sand, through the opening surrounding the candle, both being contained by the vessel. After the sand and candle ritual is performed, the present invention may be kept and displayed as a memento where the mix of colored granules and candle are all visible.

In the best mode, the apparatus consists of a candle pillar affixed inside a transparent of translucent enclosure. The pillar of said candle is positioned so as to be at or near the visual center of the enclosure, with the candle wick positioned near the mouth of the enclosure. The enclosure is made from glass, crystal, plastic or similar. In employing the invention during a marriage ceremony each person participating holds a small container filled with sand or other granular substance of a unique color. Each person then takes a turn pouring a small amount of sand into the enclosure of the present invention. The sand should be poured to create a layered look. That is, the different colors of sand should not be poured so that the grains are homogeneously intermixed. Once the sand pouring is complete each person will then hold an individual lit candle. With synchronicity each person will then bring the flaming end of his or her lit candle to the wick of the common candle until the wick of the common candle ignites into a self sustaining flame. Following the ceremony the flame of the common candle is extinguished, and the enclosure, now filled with sand, may be kept as a keepsake memento.

### DRAWINGS

### Brief Descriptions of the Figures

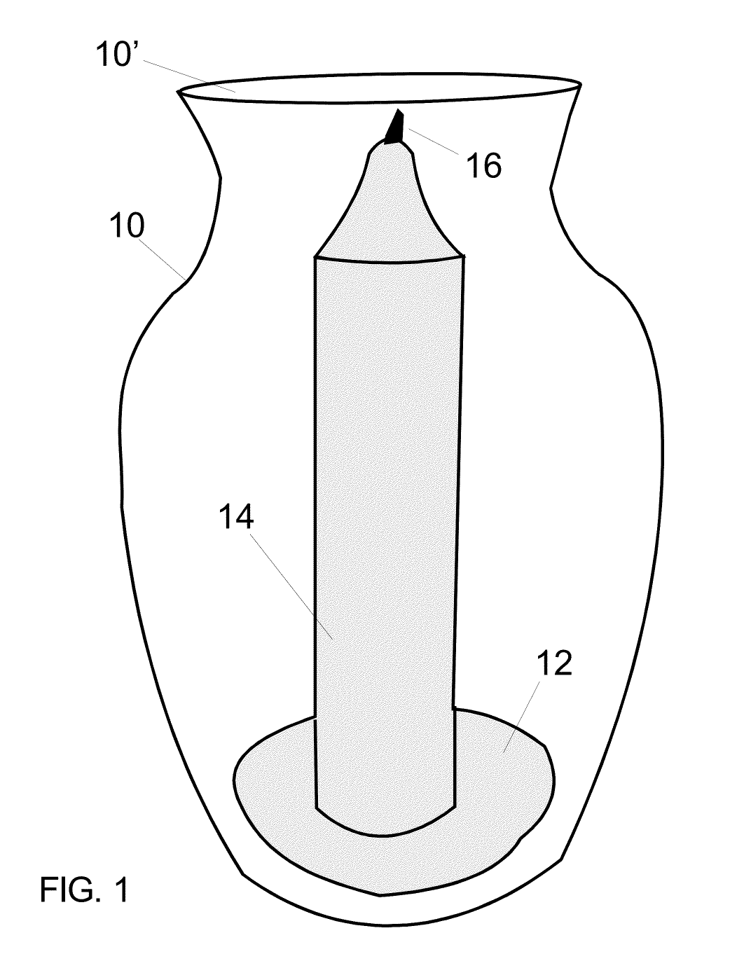

FIG. 1 is a front view of the apparatus before granular material is added

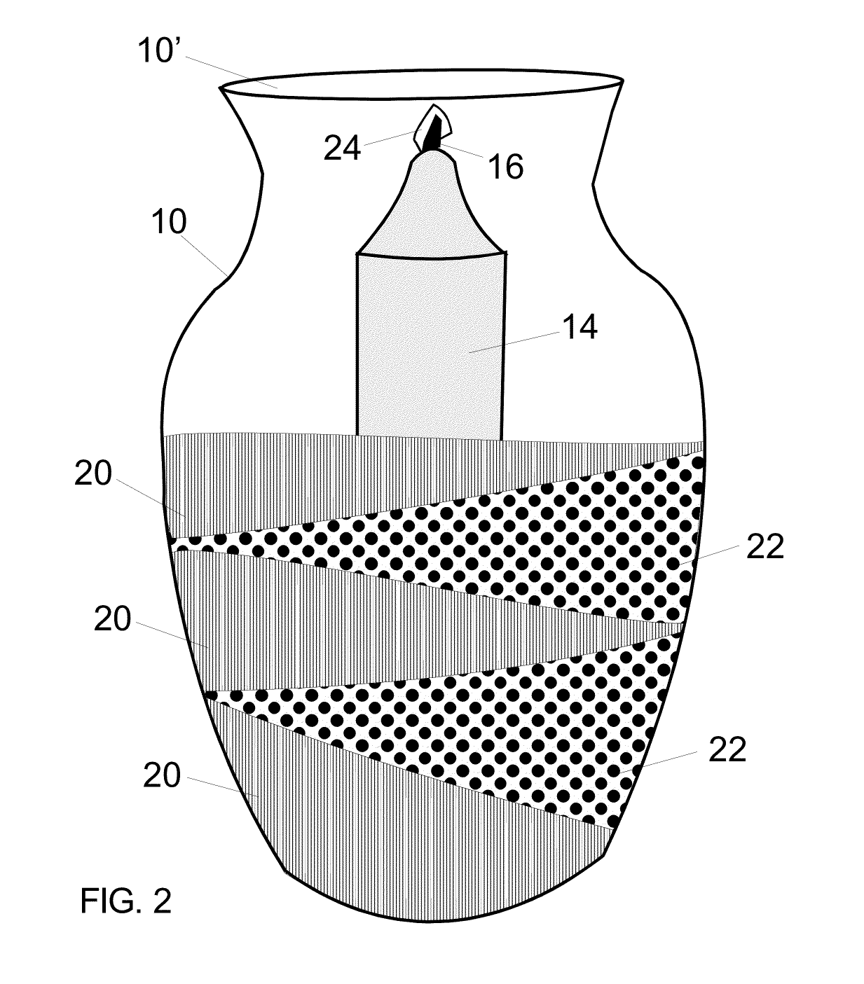

FIG. 2 is a front view of the apparatus after the granular material has been added and the common candle has been lit

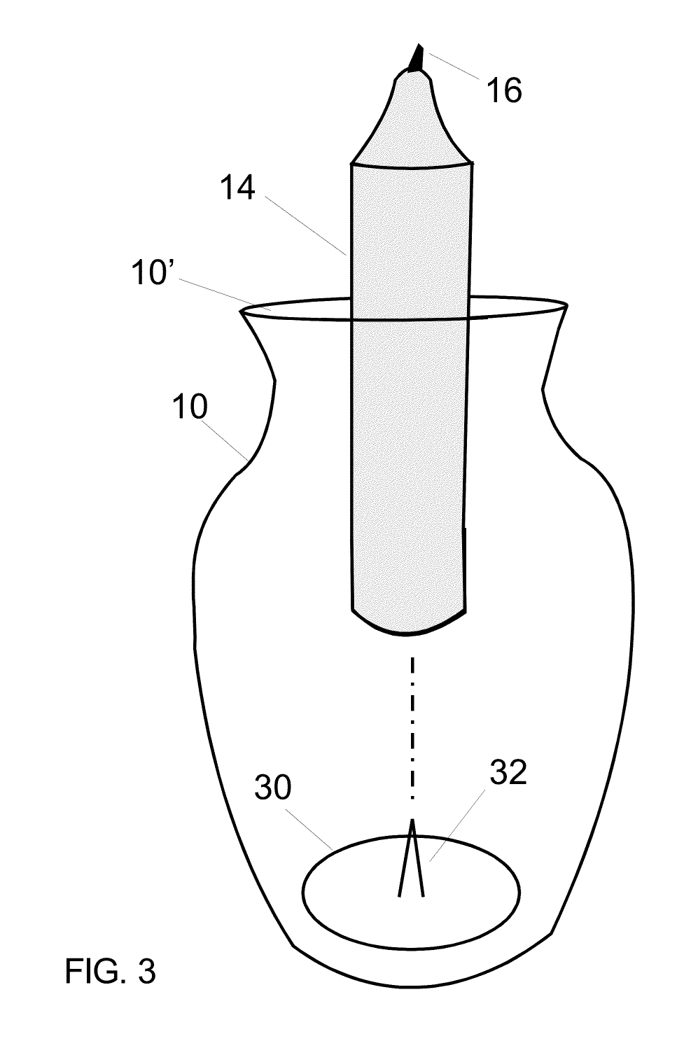

FIG. 3 is an exploded front view of an alternative embodiment where the enclosure incorporates a candle stabilizing protrusion

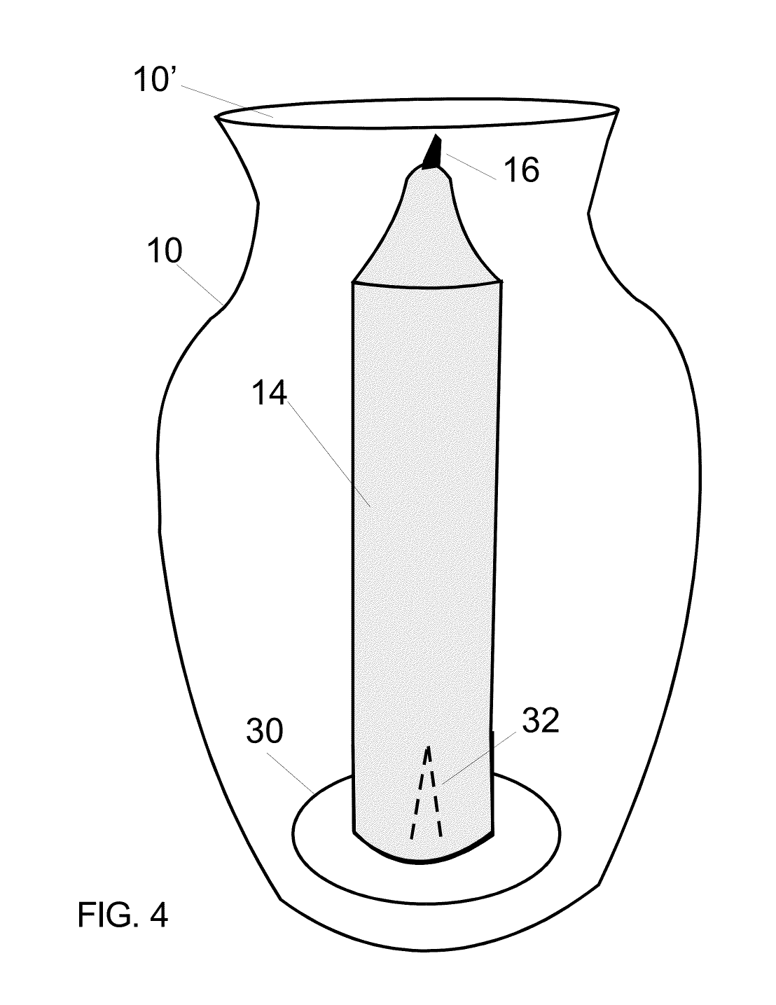

FIG. 4 is a front of an alternative embodiment after the candle pillar is placed onto the stabilizing protrusion

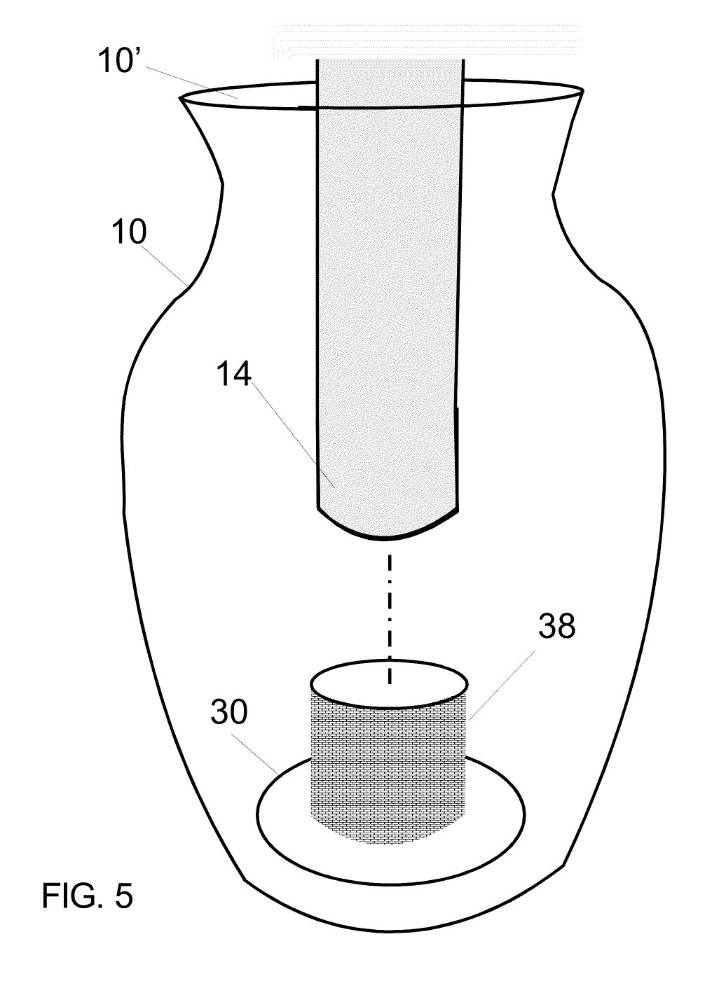

FIG. 5 is a front exploded view of an alternative embodiment utilizing a candle supporting pocket

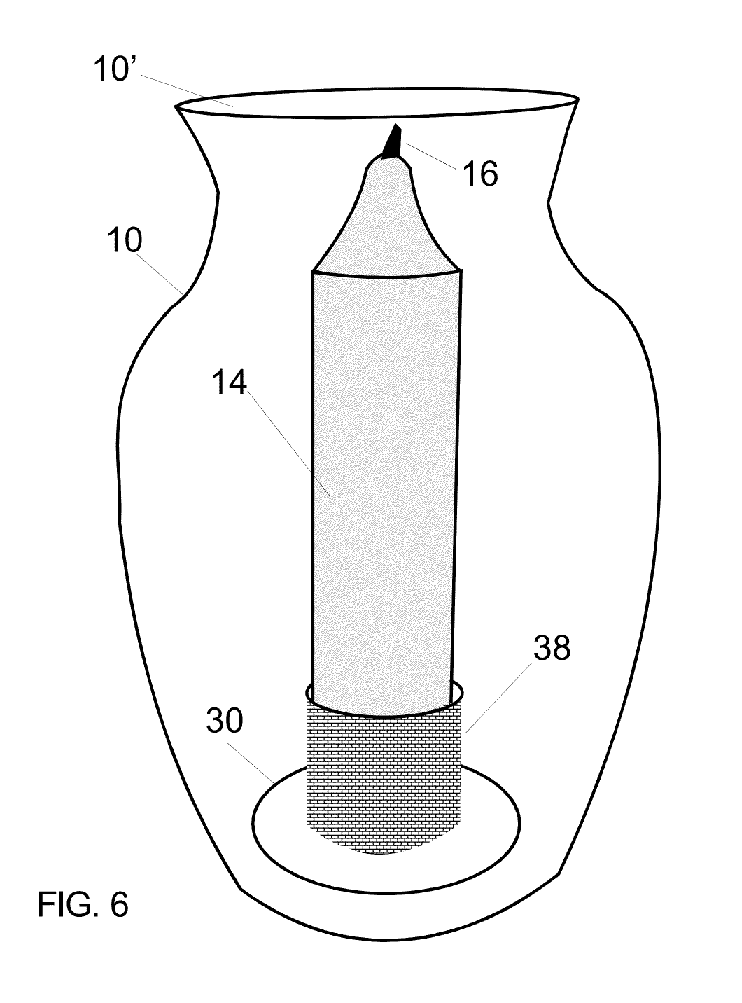

FIG. 6 is a front view of an alternative embodiment utilizing a candle supporting pocket

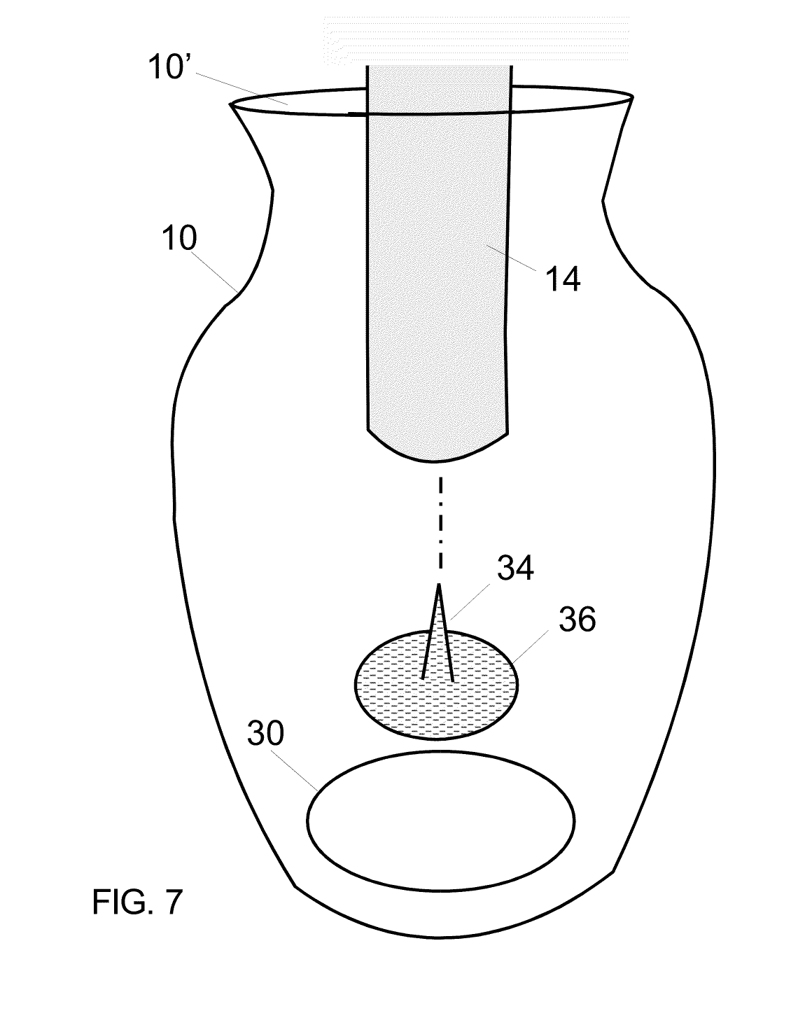

FIG. 7 is an exploded front view of an alternative embodiment employing a separate candle stabilizing part

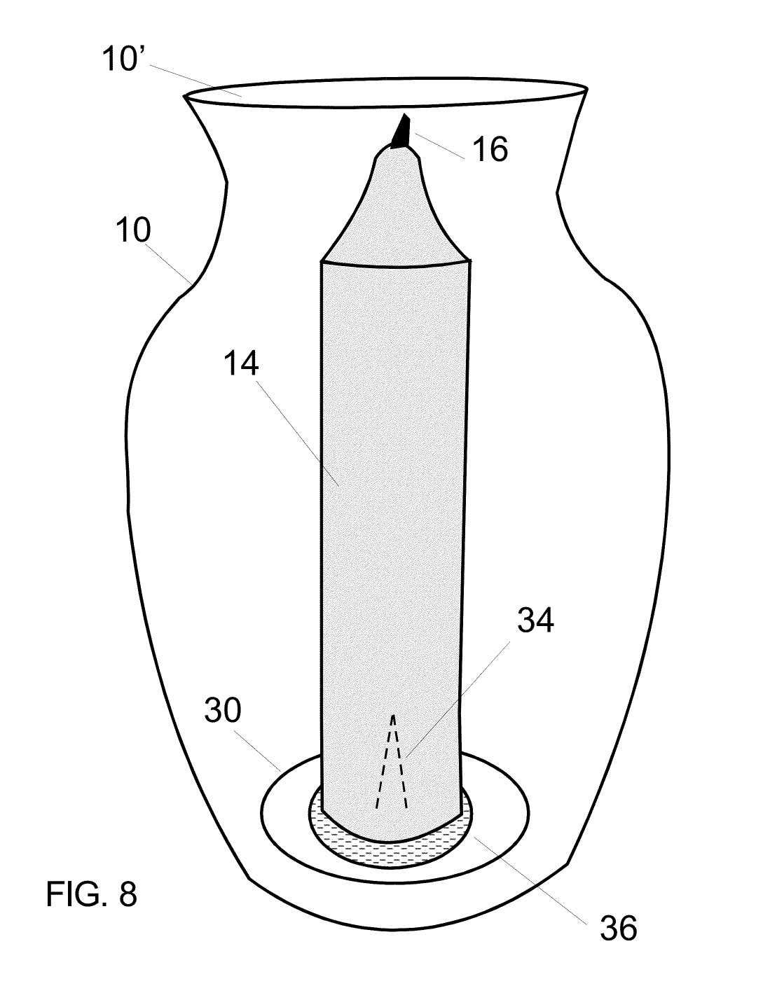

FIG. 8 is a front view of an alternative embodiment with the candle placed onto the separate candle stabilizer, with both candle and stabilizer resting inside the enclosure

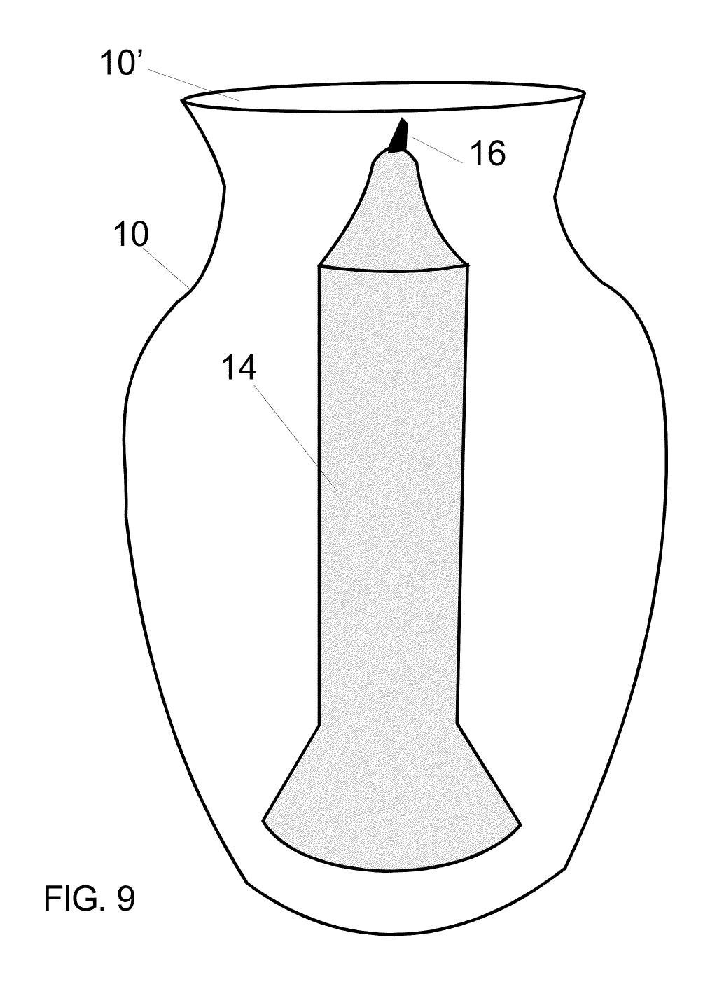

FIG. 9 is a front view of an alternative embodiment where the shape of the candle is wider at the bottom of the candle than at the top of the candle, eliminating or reducing the necessity to employ a candle stabilizing protrusion

### REFERENCE NUMERALS

10 Enclosure
10′ Enclosure portal
12 Candle base
14 Common candle pillar
16 Common candle wick
20 Colored granular material
22 Colored granular material
24 Lit flame of common candle
30 Bottom base of enclosure
32 Candle stabilizing protrusion
34 Accessory stabilizing protrusion
36 Accessory stabilizing base
38 Candle stabilizing pocket

### DETAILED DESCRIPTION

### FIGS. 1 through 2

### Preferred Embodiment

FIG. 1 is a view of the assembled apparatus from the front in best mode before the granular material is added. In this instance, common candle pillar 14 is contained inside enclosure 10. Common candle pillar 14 is joined to candle base 12. Common candle base 12 is of sufficient width to provide physical stability for 14 to maintain the position of 14 relative to 10. The common candle wick 16 is positioned near the enclosure opening 10′.

FIG. 2 is a view of the apparatus from the front side after granular material has been added and the common candle wick 16 has been lit. Colored granular material 20 and 22 each have unique colored appearances with respect to one another. The layers and positioning of the sands 20 and 22 in FIG. 2 are representative of the appearance that the granular material may have after they are poured into the enclosure 10, but the illustration is not bound to any specific shape, thickness, slope nor dimension.

### Assembly and Operation

### Preferred Embodiment

The present invention may be implemented with any size or style of enclosure the practitioner chooses applicable. A vase-type enclosure composed of nearly transparent glass walls may be employed as enclosure 10. Enclosure 10 should have an opening 10′ oriented toward the top of the apparatus. Opening 10′ should be of sufficient diameter to permit the placement of a candle through 10′ into the interior portion of 10. Opening 10′ should also be of sufficient diameter to permit the pouring of granular material, such as sand, through 10′ into the interior volume contained by 10. Candle pillar 14 should be composed of a material similar to those of commonplace candles available to consumers, such as wax, paraffin or similar substance capable of supporting combustion. Candle wick 16 should be composed of a material, such as braided cotton or similar, and be embedded inside 14.

One method to assemble this apparatus is to apply heat to the bottom of the enclosure 10. Common candle pillar 14 is placed inside 10. The bottom of 14 will melt due to the heat at the bottom of 10. The melting candle wax forms candle base 12. 14 is held in position until heat is removed and 12 is allowed to cool and solidify. For aesthetic reasons 14 should appear to be in a vertical or near vertical position, although this is not a requirement. Wick 16 should be in near proximity to opening 10′. The apparatus, consisting of the enclosure 10 and the common candle 14 affixed within 10, is ready for use in the ritual ceremony.

The exact order of operation and materials employed for and during the ritual ceremony, as well as the type of event where the apparatus is being demonstrated, may be varied by the practitioner. However in best mode, the enclosure 10 with unlit candle 14 will be placed in view of the audience being served. Those persons directly participating in the ceremony, such as a bride and groom, should each be given an amount of granular material (e. g. sand) inside a container that each participant holds separately. The granular material for each participant should be of an apparent color or consistency distinct from that of the other participant or participants. One of the participants should then pour a fractional amount of the granular material from their own assigned container through enclosure opening 10′ into enclosure 10. The next participant should do a similar action by pouring granular material from their own assigned container through 10′ into enclosure 10. The procedure then repeats, with each participant taking a turn at pouring their granular material into enclosure 10, until enclosure 10 is deemed sufficiently full, or until the participants have exhausted their supply of individualized granular material. In the best mode the granular material should be poured into 10 in such a manner that the different granular materials form visually distinct regions, rather than becoming homogenized into granular material of singular appearance. A sufficient length of 14 should also remain visible above 20 and 22 allowing direct access to wick 16.

Immediately following the conclusion of the pouring of the granular material, each participant should be given a separate lit candle of their own. Each participant then simultaneously brings the lit portion of their individual candles to the proximity of unlit wick 16, until such time as 16 is able to achieve self sustaining combustion in conjunction with candle pillar 14. Each participant may then dispose of their individual candles, while permitting 16 to continue combustion. At this point the active portion of the ritual may be concluded. However the enclosure 10, with colored granular material 20 and 22 and candle 14 inside, may be relocated and displayed for an indefinite period as a memento of the occasion. In best mode the candle wick 16 should be extinguished while a sufficient length of 14 remains visible above 20 and 22.

### Additional Embodiments

### FIGS. 3 through 9

Alternative embodiments exist which provide slight differences in the construction or configuration of present invention, all of which continue to be encompassed by the scope and spirit of the present invention. Although discussion of the best mode described pouring the granular material prior to the lighting of the candle wick 16, the present invention is also applicable to the practitioner choosing to light candle wick 16 before pouring of the granular materials 20 and 22. The best mode discussion also presented a method to apply heat to the bottom of 10, which would cause the bottom of candle 14 to melt and form candle base 12. However the practitioner may also choose as an alternative to place a separate piece of wax or wax-like material into 10, initiate the melting of this separate wax piece to form candle base 12, and then orient 14 onto 12 inside 10. Candle base 12 need not necessarily be a wax-like material. 12 could also be a hardening plastic, resin, epoxy or similar which fulfills the purpose of securing candle 14 into a position within 10.

FIG. 3 illustrates an exploded view of an alternative embodiment where enclosure 10 includes at the interior bottom portion of 10 a protruding element 32. For illustrative purposes the bottom base of 10 is highlighted by 30 in FIG. 3. Bottom base 30 would typically exist on the bottom underside of 10 and permit 10 to stand in a stable position when 10 is placed upon a suitable flat surface. Protruding element 32 extends upward from the interior bottom portion of 10 and penetrates the lower portion of 14 when 14 is placed on top of 32 within 10. FIG. 4 shows the configuration of the elements after candle body 14 has been placed inside 10. 32 is typically hidden from plain view after candle body 14 has been mounted. The penetration of 32 into 14 provides physical support to maintain the relative position of 14 within 10.

FIG. 5 illustrates an exploded view of an alternative embodiment where a cup or pocket-like element 38 exists at the bottom interior of the enclosure 10. 38 is a hollow structure which facilitates the insertion of candle body 14 into its interior. Once 14 has been inserted into 38 the vertical walls of 38 provide physical support to hold candle body 14 in a stable position relative to 10. FIG. 6. Illustrates this alternative embodiment after candle body 14 has been inserted into 38.

FIG. 7 is an exploded view illustration of an alternative embodiment where a separate part consisting of a base 36 and protrusion 34 is added to the assembly. The bottom portion of candle body 14 would be placed over protrusion 34 allowing 34 to penetrate some distance into the bottom portion of 14. After penetration the candle body 14, along with the accessory element 34 and 36 would be placed inside the interior of 10. The penetration of 34 into 14 provides physical support to maintain the relative position of 14 within 10. The diameter of 36 should be of sufficient width such that the candle body 14 exists in a stable vertical or near vertical position within 10 through forces transmitted between 14 and 36 via 34. FIG. 8 is an illustration of this alternative embodiment after 34 has penetrated 14 and elements 14, 34 and 36 have together been placed inside enclosure 10. Protrusion 34 would typically be hidden from plain view after penetration and placement into 10.

FIG. 9 is an illustration of an alternative embodiment where the shape of candle body 14 is such that the candle body 14 is able to support its own physical position relative to 10 after 14 has been inserted into the interior of 10. For this illustration candle body 14 has been manufactured such that the bottom portion of 14 is wider than the upper portion of 14. With this type of widened base shape candle body 14 would more naturally maintain a vertical position compared to a candle body having a uniformly slender body.

Variations and combinations of the embodiments presented in FIGS. 1 through 9 are possible to achieve the purpose of securely mounting the candle body 14 inside the interior of enclosure 10. The practitioner is advised to allow for enough unused volume inside the interior of 10 after candle body 14 has been mounted such that the desired amount of granular material may be added to the apparatus during the ceremonial ritual.

### CONCLUSION, RAMIFICATIONS, AND SCOPE

Accordingly, the reader will understand that the present invention provides a novel combination of two previously separate and distinct rituals utilized particularly at ceremonies of marriage. The previous “unity candle” and “sand ceremony” rituals have been separately practiced by uniting couples for decades. The present invention now facilitates a means for uniting couples or uniting families to enjoy the spectacle and benefits of both a sand ceremony and a unity candle being practiced together. In particular the apparatus of the present invention becomes a memorable keepsake that may be cherished and displayed by the family after the formal event has ended.

The present invention is readily fabricated using existing technologies of vase formation and candle making Although the description above has presented some specificities about shape, style and choice of materials, these should only be considered aids to visualization of the construction and operation of the device. By no means should said specificities be interpreted as limitations of any embodiment. The scope of the invention should be judged by the claims of this patent and their legal equivalents.

I claim:

1. A ceremonial apparatus comprising: a hollow enclosure that is capable of containing a volume of granular material; wherein said enclosure has an portal located near the top portion of said enclosure and said portal facilitates materials and objects to be transported into the interior of said enclosure; a candle body affixed within the interior of said enclosure; the wick of said candle body being in near proximity to the said portal of said enclosure.

2. The ceremonial apparatus of claim 1 wherein said enclosure is composed of glass.

3. The ceremonial apparatus of claim 1 wherein said enclosure is composed of a polymer material.

4. The ceremonial apparatus of claim 1 further comprising: a protrusion extending from the bottom interior of said enclosure upon which said candle body connects.

5. The ceremonial apparatus of claim 1 further comprising: a hollow pocketed element attached to the bottom interior of said enclosure; said candle body being inserted into said hollow pocketed element.

6. The ceremonial apparatus of claim 1 further comprising: a stabilizing element consisting of a protrusion and a base; the protrusion of said stabilizing element being inserted into the bottom portion of said candle body; said base of said stabilizing element connecting the interior of said enclosure with said protrusion.
